(19) United States
(12) Patent Application Publication
(10) Pub. No.: US 2019/0186632 A1
(43) Pub. Date: Jun. 20, 2019

(54) INTEGRATED DEBRIS BARRIER ON METAL FACE SEALS

(71) Applicant: Caterpillar, Inc., Peoria, IL (US)

(72) Inventors: Connor Haas, Peoria, IL (US); Alexander Nikolic, Peoria, IL (US)

(73) Assignee: Caterpillar Inc., Peoria, IL (US)

(21) Appl. No.: 15/848,916

(22) Filed: Dec. 20, 2017

(51) Int. Cl. F16J 15/28; F16J 15/34; F16D 3/226

(52) U.S. Cl. CPC F16J 15/28; F16D 2003/22316; F16D 3/226; F16J 15/344

(57) ABSTRACT

A sealing assembly having a first metal seal ring including a first lateral face defining a first seal surface and a second metal seal ring including a second lateral face defining a second seal surface that is configured to form a face-to-face seal with the first seal surface. The first lateral face includes a laterally-facing groove positioned radially outward of the first seal surface. An annular debris barrier is configured to be received within the groove.

### TECHNICAL FIELD

The present disclosure relates generally to face seal assemblies, and more particularly relates to face seal assemblies having an integrated abrasive debris barrier.

### BACKGROUND

Face seal assemblies are a type of mechanical seal. Face seal assemblies are used in many types of industrial equipment, including trucks and track-type machines, near relative rotating components of the equipment, such as track roller assemblies, idler assemblies, final drive assemblies, axle assemblies, etc. These seals are designed to protect underlying components, such as bearings, by keeping out debris and by preventing leakage of protective lubricants. Such equipment typically operates in environments that are highly destructive to seals and consequently to the underlying bearings.

Face seal assemblies usually include a pair of contacting seal rings formed of metal or other durable, hard material. The seal rings rotate relative to one another in face-to-face contact to provide a positive face seal. One of the seal rings is considered a dynamic seal ring and is associated with a rotating portion of the equipment. The other seal ring is considered a stationary seal ring and is associated with a stationary portion of the equipment. Each of the seal rings may be axially-movable relative to its associated portion.

There are a variety of face seal assembly designs. Typically, the seal rings are biased together by a resilient load ring, such as a toric or rectangular shaped ring. One type of face seal is a conventional Duo-Cone seal which includes a resilient load ring that is positioned on an angled portion of each seal ring to provide a force to bias the seal rings toward each other to maintain constant sealing engagement. While face seal assemblies provide a barrier to dirt, mud, and other debris, some deterioration of the metal face seals is inevitable due to the ingress of environmental abrasive particulates, such as air-borne dust, into the seal interface.

German Patent Application No. DE 102012012085 A1 to Zutz et al. is directed to a mechanical drive seal assembly having two slide rings, one of which is stationary (the counter ring) and one that rotates (the slip ring). The two sliding rings are each a part of a mechanical drive gasket, and mounted in two opposing housings. The sliding surface of the sliding ring and sliding surface of the counter ring are pressed tightly together, and are planar-lapped to ensure a tight fit against each other. Elastomeric rings are typically made of a high quality synthetic rubber, and are used to apply force which holds the sliding rings in tight contact with each other. There is a groove for catching dirt produced by a cut if the sliding surfaces in the outer region of the slip rings, the geometrical shape of which is intended to catch dirt and water that may easily be cleaned from the slip rings. A groove with a deliberately open trapezoidal shape is described.

### SUMMARY

In an exemplary embodiment, a sealing assembly includes a first metal seal ring having a first lateral face defining a first seal surface, and a laterally-facing groove in the first lateral face, the laterally facing groove positioned radially outward of the first seal surface; a second metal seal ring including a second lateral face defining a second seal surface that is configured to form a face-to-face seal with the first seal surface; and an annular debris barrier configured to be received within the groove.

In another exemplary embodiment, a method of sealing between a rotating metal seal ring and a stationary metal seal ring includes creating a first debris barrier by forming a metal-to-metal face seal between the two metal seal rings; and creating a second debris barrier by capturing a barrier material between the two metal seal rings at a position radially outward of the first debris barrier.

In another exemplary embodiment, a drive assembly includes a stationary housing; a rotatable housing; a first metal seal ring attached to the stationary housing, the first metal seal ring including a first lateral face defining a first seal surface, and a laterally-facing groove in the first lateral face, the laterally facing groove positioned radially outward of the first seal surface; a second metal seal ring attached to the rotatable housing for rotation therewith, the second metal seal ring including a second lateral face defining a second seal surface that is configured to form a face-to-face seal with the first seal surface; and an annular debris barrier configured to be received within the groove.

### BRIEF DESCRIPTION OF THE DRAWINGS

Further features and advantages of the invention will become apparent from the description of embodiments using the accompanying drawings. In the drawings:

FIG. 1 is a cross-section view of an exemplary embodiment of a drive assembly according to the present disclosure;

FIG. 2 is cross-section view of the drive assembly as indicated in FIG. 1, enlarged in the area of a face seal;

FIG. 3 is a cutaway view of an exemplary embodiment of a seal ring of the face seal of FIG. 2;

FIG. 4 is a cutaway view of an exemplary embodiment of a seal assembly according to the present disclosure; and

FIG. 5 is a cross-section view of a debris barrier of the seal assembly of FIG. 4.

### DETAILED DESCRIPTION

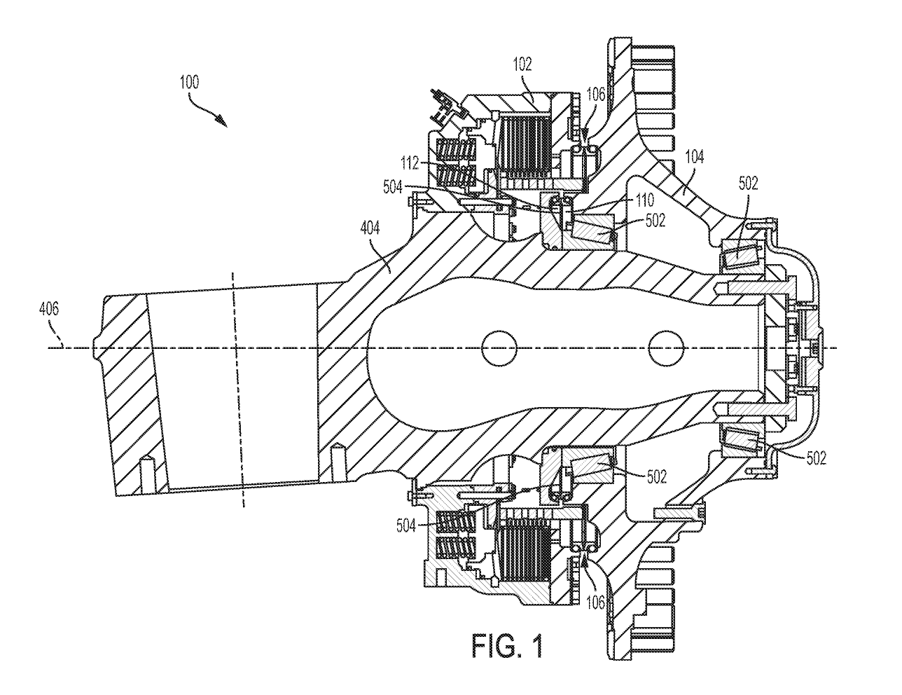

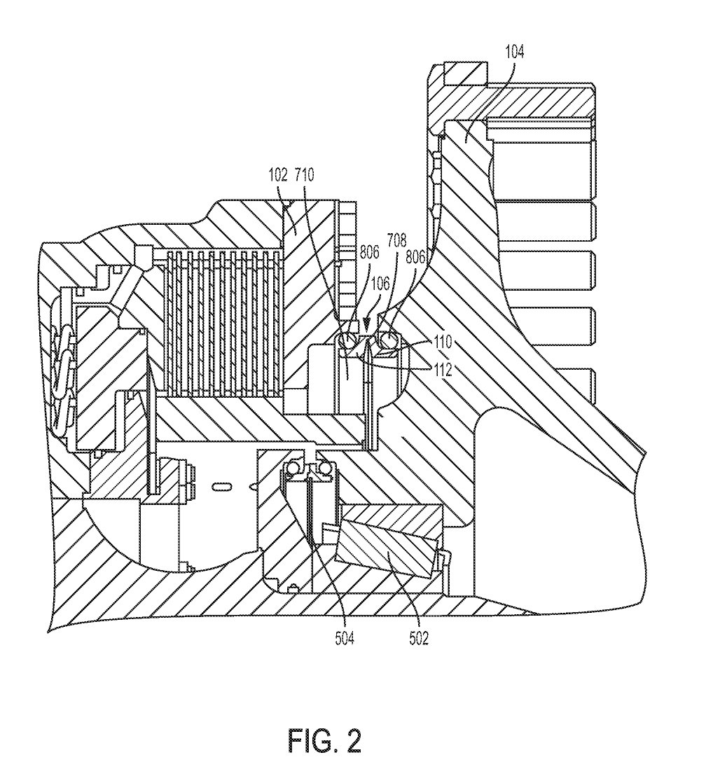

FIG. 1 illustrates a cross section of an exemplary embodiment of a drive assembly 100. The drive assembly 100 may contain a rotatable housing or component 104, a stationary housing or component 102, a stationary member 404, such as for example, a wheel shaft, and one or more roller bearing assemblies 502. While the exemplary embodiment is illustrated as a drive assembly, the disclosed seal assemblies may be used in any application track where a metal face seal may be used, such as, but not limited to roller assemblies, idler assemblies, final drive assemblies, axle assemblies, and the like.

The rotatable housing 104 of the drive assembly 100 is positioned to rotate about the stationary member 404. The one or more roller bearing assemblies 502 may be positioned between the rotatable housing 104 and the stationary member 404 to facilitate rotation of the rotatable housing 104 relative to the stationary member 404.

The drive assembly 100 may include one or more sealing assemblies positioned at interfaces between the rotatable housing 104 and the stationary housing 102 and/or stationary member 404. The one or more sealing assemblies may be configured in a variety of ways. In some embodiments, the sealing assemblies are configured as metal face seal assemblies or floating seal assemblies. In the exemplary embodiment, the sealing assemblies include a first metal face seal assembly 106 and a second metal face seal assembly 504 positioned inward of the first metal face seal assembly 106. The first and second metal face seal assemblies 106, 504 may be configured substantially the same. Thus, the description of the first metal face seal assembly 106 applies equally to the second metal face seal assembly 504. In other embodiments, however, the first metal face seal assembly 106 is configured differently from the second metal face seal assembly 504.

The first metal face seal assembly 106 may include a first metal seal ring 110 connected to the rotatable housing 104, a second metal seal ring 112 connected to the stationary housing 102 or stationary member 404 and one or more annular debris barriers 802 (FIG. 4). The first metal seal ring 110, the second metal seal ring 112, and the annular debris barrier 802 may be configured in a variety of ways, such as for example, different dimensions, shapes, and arrangement orientation relative to each other. In the illustrated embodiment, the first metal face seal assembly 106 has one annular debris barrier 802. In other embodiments, the first metal face seal assembly 106 may have two, three, four, or more annular debris barriers 802. Each of the annular debris barriers 802 may be received in a separate groove or recess. For example, a second groove adjacent or two or more debris barriers may be positioned within a single groove or recess.

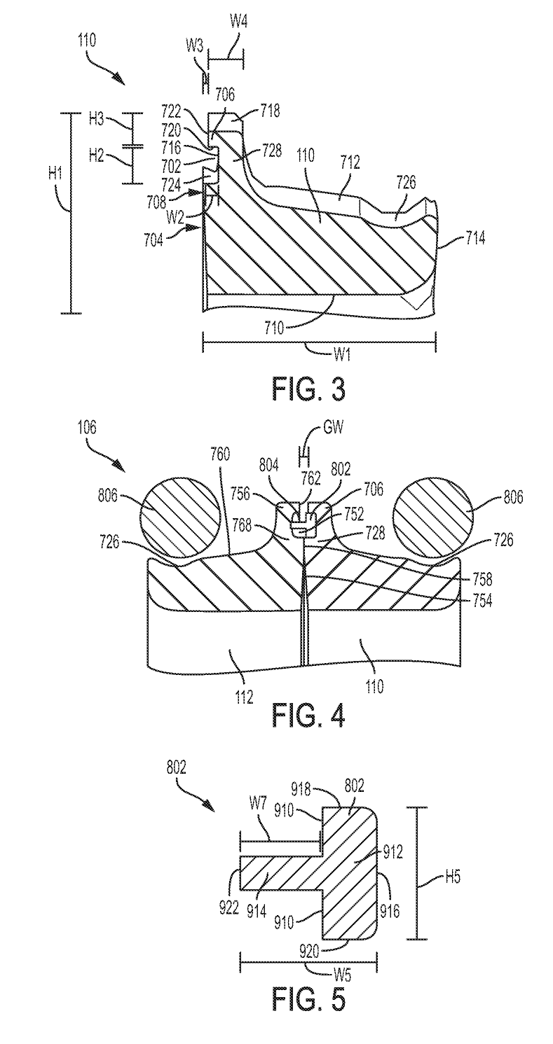

FIG. 3 illustrates an exemplary embodiment of a cross-section of a portion of the first metal seal ring 110. In the exemplary embodiment, the second metal seal ring 112 may be substantially the same as the first metal seal ring 110. Thus, the description of the first metal seal ring 110 may apply equally to the second metal seal ring 112. In other embodiments, however, the first metal seal ring 110 and the second metal seal ring 112 may have different configurations.

The first metal seal ring 110 is generally annular and may include a radially inward facing surface 710, a radially outward facing surface 712 opposite the radially inward surface 710, a first lateral face 704 extending between the radially inward surface 710 and the radially outward surface 712, and a second lateral face 714 opposite the first lateral face 704. The first lateral face 704 includes a seal surface 708 configured to engage and form a metal-to-metal face seal with the second metal seal ring 112. The radially outward facing surface 712 may include a recess 726 adjacent or near the second lateral face 714 for receiving a toric 806 (FIG. 4).

The first metal seal ring 110 has cross section with an overall height H1 and an overall width W1. In the exemplary embodiment, the overall width W1 of the first metal seal ring 110 is greater than the overall height H1. In other embodiments, however, the overall width W1 of the first metal seal ring 110 may be equal to or less than the overall height H1. In the exemplary embodiment, the width W1 may be in the range from about 6 mm to about 50 mm and the overall height H1 may be in the range from about 8 mm to about 30 mm.

The first metal seal ring 110 may include a flange 728 extending radially outward from the radially outward facing surface 712. The flange 728 may be positioned near or adjacent the first lateral face 704 and radially outward from the seal surface 708. The flange 728 includes a laterally-facing groove 702 and a laterally-extending lip 706 positioned at a radially outer portion of the flange 728 (i.e., radially outward of the groove 702). The lip 706 includes a lateral surface 722 and a radially outward facing surface 718.

While the groove 702 is described as being formed in the flange 728, it is understood that the lateral surface 722 of the lip 706 may be considered a portion of the first lateral face 704. Thus, describing the groove 702 as being formed in the first lateral face 704 is equally accurate. In addition, in some embodiments, the first metal seal ring 110 may not include a flange 728, thus the groove 702 is formed in the first lateral face 704 of the first metal seal ring 110 radially inward of the radially outward facing surface 712.

The groove 702 may have an interior lateral surface 716, an upper radial surface 720, and a lower radial surface 724. In the exemplary embodiment, the upper radial surface 720 and the lower radial surface 724 are parallel. In other embodiments, however, the upper radial surface 720 and the lower radial surface 724 may not be parallel.

The dimensions of the groove 702 are configured to be sufficient to receive at least a portion of the debris barrier 802 within the groove 702. The groove 702 may have a height H2 and a width W2. In one exemplary embodiment, the height H2 of the groove 702 may be in the range from about 0.5 mm to about 8 mm. In one exemplary embodiment, the width W2 of the groove 702 may be in the range from about 0.5 mm to about 6 mm.

The lip 706 has a width W4 and the lateral face 722 has a height H3. In the exemplary embodiment, the width W4 of the lip 706 is in the range from about 1 mm to about 10 mm. In the exemplary embodiment, the height H3 of the lateral face 722 is in the range from about 0.5 mm to about 8 mm.

In the exemplary embodiment, the lateral surface 722 of the lip 706 is parallel to the lateral face 704 and offset in the direction of the second lateral face 714 by a distance W3. In other embodiments, however, the lateral surface 722 may not be parallel to the lateral face 704. In the exemplary embodiment, the offset distance W3 is in the range from about 0.12 mm to about 6 mm.

As indicated, the second metal seal ring 112 may be substantially the same as the first metal seal ring 110. Thus, the second metal seal ring 112 may include a first lateral surface 754, a radially outward facing surface 760, a seal surface 758, a groove 752, and a flange 768 forming a lip 756 having a second lateral surface 762. In some embodiment, the second metal seal ring 112 does not include the groove 752. The groove 702 in the first metal seal ring 112 may be configured to receive the entire annular debris barrier 802. The first lateral surface 754 of the second metal sealing ring 112 may serving to capture, along with the groove 702 in the first metal seal ring 110, the debris barrier 802 between the first and second metal seal rings 110, 112.

Referring to FIG. 5, the debris barrier 802 is configured to be at least partially received within the groove 702. The debris barrier 802 may be configured in a variety of ways, such as for example, different cross-sectional shapes, dimension, and materials used. Any configuration that may filter out fine debris, such as dust, or form a seal against enter of such debris, may be used. The cross-sectional shape of the debris barrier 802 can be any suitable shape, such as, but not limited to, circular, oval, or rectangular. The debris barrier shape 802 may have one or more curved or angled surfaces to help prevent the barrier from collapsing under the weight of debris. In the exemplary embodiment, the debris barrier 802 is annular with a cross-sectional shape that is generally T-shaped.

The debris barrier 802 includes a first portion 912 and a second portion 914 extending from the first portion 912. The first portion 912 includes a first surface 916, a second surface 910 opposite the first surface 916, a third surface 918 extending between the first surface 916 and the second surface 910, and a fourth surface 920 opposite the third surface and extending between the extending between the first surface 916 and the second surface 910.

The second portion 914 extends from the second surface 910 and includes an end surface 922 that is opposite and the first surface 916. In the illustrated embodiment, the second portion 914 extends perpendicularly from the first portion 912, or from the second surface 910. In other embodiments, however, the second portion 914 may be extend at an angle between 90 degrees and zero degrees from the first portion 912, or from the second surface 910. In one embodiment, the second portion 914 extends at an angle between 85 degrees and 45 degrees from the first portion 912, or from the second surface 910. In another exemplary embodiment, the second portion 914 is curved or includes one or more curved surfaces.

The debris barrier 802 may have an overall height H5, which is also the height of the first surface 916, and an overall width W5. The debris barrier 802 may compress to some degree when captured between the seal rings 110, 112 or within the groove 702. Therefore, the dimensions of the annular debris barrier 802 set forth herein, are those of the debris barrier 802 free-standing or prior to installation.

The overall height H5 of the debris barrier 802 may be configured to be closely received in the groove 702 of the first metal seal ring 110. In some embodiments, an interface fit between the overall height H5 of the debris barrier 802 and the height H2 of the groove 702 such that the debris barrier 802 is held in place within the groove 702. In the exemplary embodiment, the overall height H5 of the debris barrier is in the range from about 0.5 mm to about 8 mm.

As will be discussed below, the debris barrier 802 may be received within both the groove 702 of the first metal seal ring 110 and in the groove 752 of the second metal seal ring 112 when the seal rings are side-by-side in sealing engagement. Thus, the overall width W5 of the debris barrier 802 may be configured to be closely received and captured within the two grooves 702, 752. In some embodiments, an interface fit between the overall height H5 of the debris barrier 802 and the height H2 of the groove 702 such that the debris barrier 802 is held in place within the groove 702. In the exemplary embodiment, the overall height H5 of the debris barrier 802 is in the range from about 1 mm to about 12 mm. In the illustrated embodiment, the height H8 of the flange 728 is less than the overall height H5.

The debris barrier 802 may be made from any suitable barrier material or materials capable of filtering out fine environmental abrasives and corrosives. Suitable materials for the debris barrier 802 include, but are not limited to, rubber materials such as nitrile rubbers, including NBR, HNBR, and XNBR, and felt materials, such as a polypropelyne, non-woven polyester, or combinations thereof. In one embodiment, the debris barrier 802 includes a felt material that is bound with a nitrile rubber.

The debris barrier 802 may form an air permeable barrier that filters out fine environmental abrasives and corrosives but allows air to pass.

Referring to FIG. 4, the face seal assembly 106 is formed by arranging the first metal seal ring 110 in a side-by-side relationship with the second metal seal ring 112 such that the lateral face 704 of the first metal seal ring 110 is adjacent the lateral face 754 of the second metal seal ring 112. The metal seals rings 110, 112 may be in contact with each other near their outer circumference along their first lateral surfaces 704, 754, and in particular along the seal surfaces 708, 758.

As is known in the art, a toric 806 may be initially received in the recess 726 of each of first and second metal seal rings 110, 112. Once in operation, the torics 806 may ride up onto the radially outward facing surface 712. The torics 806 encircle the first and second metal seal rings 110, 112 to bias the seal surface 708 of the first metal seal ring 110 against the seal surface 758 of the second metal seal rings 112. The engagement of the seal surfaces 708, 758 form a first debris barrier preventing debris from entering the interface between the rotating housing 104 and the stationary housing 102.

When assembled in side-to-side relationship, the lateral surface 722 of the lip 706 on the first metal seal ring 110 faces, but is spaced apart from, the second lateral surface 762 of the lip 756 on the second metal seal ring 112. The gap width GW of the space between lateral surface 722 of the lip 706 on the first metal seal ring 110 and second lateral surface 762 of the lip 756 on the second metal seal ring 112 forms a first debris barrier or filter that is positioned at or near the outer perimeter of the metal seal rings 110, 112. The gap width GW may vary in different embodiments. In one embodiment, the gap GW is less that the width W5 of the annular debris barrier 802. In another embodiment, the gap width GW is less that the width W2 of the groove 702. In some embodiments, the gap width GW is in the range of about 0.25 mm to about 10 mm.

When assembled, the groove 702 in the first metal seal ring 110 faces the groove 752 in the second metal seal ring 112 to form a channel 804. The groove 752 in the second metal seal ring 112 may be complimentary to the groove 702 in the first metal seal ring 110. The annular debris barrier 802 is captured within the channel 804 between the first metal seal ring 110 and the second metal seal ring 112. The annular debris seal 802 may be secured within the groove 702 in any suitable manner, such as, but not limited to, a press or interference fit, an adhesive, mechanical retention structure in the groove or on the seal, or any other suitable manner. In the exemplary embodiments, the annular debris seal 802 is press fit into one or both of the grooves 702, 752. In another exemplary embodiment, the annular debris seal 802 is secured within the groove 702 by an adhesive applied to the annular debris seal 802, within the groove 706, or both. Any suitable adhesive may be used.

When the first metal seal ring 110 and the second metal seal ring 112 are biased together by the torics 806, the annular debris seal 802 is captured and retained within the channel 804. When received in the channel 804, the annular debris barrier 802 may rotate with the rotating metal seal ring in relation to the stationary metal seal ring or, alternatively, the annular debris barrier 802 may remain stationary relative to the rotating metal face ring.

In the assembled position, the annular debris seal 802 forms a second debris barrier or filter at a position adjacent to and radially outward from the interface between the seal surfaces 708, 758, but radially inward of the first debris barrier or filter formed by the space between the lateral surface 722 of the lip 706 on the first metal seal ring 110 and lateral surface 762 of the lip 756 on the second metal seal ring 112.

### INDUSTRIAL APPLICABILITY

The sealing assembly 106 may be used in any application where a metal face seal may be used. For example, the sealing assembly 106 may be used in a final drive assembly of industrial equipment, including trucks and track-type machines. The sealing assembly 106 may be used at the interface between a rotating portion of the drive assembly 100, such as the rotating housing 104, and a stationary portion of the drive assembly 100, such as a stationary housing 102.

The first metal seal ring 110 may be fixed to and therefore rotate with the rotatable housing 104 and the second metal seal ring 112 may be fixed to the stationary housing 102. A metal face seal may be formed by positioning the metal seals rings 110, 112 in a side-by-side arrangement and applying a lateral force to one or to each of the metal seals rings 110, 112 to bring the seal surfaces 708, 758 into contact with each other. The metal face seal serves as a barrier to dirt, mud, and other debris entering the interior of the drive assembly 100, and as a barrier to lubricating oil leaking out.

To enhance the life (i.e., reduce wear and corrosion) of the metal face seal, the seal assembly 106 may include two integrated debris barriers radially outward of the metal face seal. One of the debris barriers is formed by positioning the annular debris barrier 802 in the laterally-facing groove 702 formed the first metal seal ring 110 and capturing the annular debris barrier 802 in the groove 702 between the two metal seal rings 110, 112. The second metal seal ring 112 may have a complimentary groove 752 that receives at least a portion of the annular debris barrier 802. A second debris barrier is formed by creating a narrow gap between surfaces on the outer edges of the of the metal seal rings 110, 112, such as the lateral surfaces 722, 762 on the lips 706, 756.

The integrated debris barriers act as air filters, preventing particulates from entering the interface between the metal face seal surfaces. Further, the annular debris barrier material may block oil that may purge from the metal face seal during operation. This oil, if exposed to airborne abrasive particulates, may mix with the particulates and clog the opening and carry the abrasives into the metal face seal.

Integrated debris barriers also ensure that the barriers are always properly positioned to filter out particulates. Exterior, stand along barriers may not make sufficient contact with the metal face seal throughout the life cycle of the metal face assembly.

With the use of an integrated debris barrier, that is integrated with the metal face seal such as described in the embodiments herein, the debris barrier may maintain a better alignment and have superior followability with the metal face seal, making it more effective at filtering out debris.

Furthermore, the integrated debris barrier is able to leverage the sealing assembly 106 load rings (e.g. torics 806) to absorb relative axial motion of the sealing rings 110, 112. Conversely, a non-integrated debris barrier, such as a stand-alone barrier positioned radially outward of the sealing rings 110, 112 would need to absorb both axial and radial motion of the system.

While the disclosed embodiments have been illustrated and described in detail in the drawings and foregoing description, such illustration and description is to be considered as exemplary and not restrictive in character, it being understood that only certain exemplary embodiments have been shown and described and that all changes and modifications that come within the scope of the disclosure are desired to be protected. The disclosed embodiments are not limited to use drive assemblies, such as final drive assemblies. Rather, they may be used in any application where a metal face seal may be used, such as, but not limited to, track roller assemblies, idler assemblies, axle assemblies, and the like.

It will be apparent to those skilled in the art that various modifications and variations can be made to the disclosed dosing system. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A sealing assembly, comprising:
a first metal seal ring including
a first lateral face defining a first seal surface, and
a laterally-facing groove in the first lateral face, the laterally facing groove positioned radially outward of the first seal surface;
a second metal seal ring including
a second lateral face defining a second seal surface that is configured to form a face-to-face seal with the first seal surface; and
an annular debris barrier configured to be received within the groove.

2. The sealing assembly of claim 1, wherein the second metal seal ring comprises a second groove complimentary to the groove in the first lateral face, the second groove located in the second lateral face radially outward of the second seal surface and configured to receive at least a portion of the annular debris barrier.

3. The sealing assembly of claim 1, wherein
the first metal seal ring further comprises:
a radial outer face; and
a flange extending radially outward from the radial outer face and proximate the first lateral face,
wherein the first lateral face extends along the flange and the laterally facing groove is formed in the flange.

4. The sealing assembly of claim 3, wherein a radially outer portion of the flange defines a laterally-extending lip.

5. The sealing assembly of claim 3, wherein the groove is positioned radially inward from the lip.

6. The sealing assembly of claim 3, wherein the second metal seal ring further comprises:
a second radial outer face; and
a second flange extending radially outward from the second radial outer face and proximate the second lateral face,
a second laterally-facing groove formed in the second flange and configured to receive at least a portion of the annular debris barrier.

7. The sealing assembly of claim 6, wherein a second radially outer portion of the second flange defines a second laterally-extending lip.

8. The sealing assembly of claim 7, wherein when second seal surface forms a face-to-face seal with the first seal surface, the laterally extending lip forms a second debris barrier with the second laterally-extending lip.

9. The sealing assembly of claim 8, wherein the annular debris barrier has a width, wherein a gap is formed between the laterally extending lip and the second laterally-extending lip when second seal surface forms a face-to-face seal with the first seal surface, and wherein the gap is less than the width.

10. The sealing assembly of claim 9, wherein the gap has a width in the range of about 0.25 millimeters to about 8 millimeters.

11. The sealing assembly of claim 1, wherein the annular debris barrier includes a rubber, felt, or polyester material.

12. A method of sealing between a rotating metal seal ring and a stationary metal seal ring, the method comprising:
creating a first debris barrier by forming a metal-to-metal face seal between the two metal seal rings; and
creating a second debris barrier by capturing a barrier material between the two metal seal rings at a position radially outward of the first debris barrier.

13. The method of claim 12, further comprising:
creating a third debris barrier by establishing a gap between the two metal seal rings at a position radially outward of the second debris barrier, wherein the width of the gap is less than the width of the barrier material.

14. The method of claim 13, wherein the third debris barrier blocks particles greater than 0.25 millimeters from reaching annular debris barrier.

15. The method of claim 12, wherein the step of capturing a barrier material between the two metal seal rings further comprises creating a groove in at least one of the two metal seal rings and positioning the barrier material within the groove.

16. The method of claim 12, wherein the step of capturing a barrier material between the two metal seal rings further comprises creating a groove in each of the two metal seal rings and positioning the barrier material within both of the grooves.

17. The method of claim 12, wherein the barrier material includes a rubber, felt, or polyester material.

18. A drive assembly, comprising:
a stationary housing;
a rotatable housing;
a first metal seal ring attached to the stationary housing, the first metal seal ring including:
a first lateral face defining a first seal surface, and
a laterally-facing groove in the first lateral face, the laterally facing groove positioned radially outward of the first seal surface;
a second metal seal ring attached to the rotatable housing for rotation therewith, the second metal seal ring including:
a second lateral face defining a second seal surface that is configured to form a face-to-face seal with the first seal surface; and
an annular debris barrier configured to be received within the groove.

19. The drive assembly claim 18, wherein the second metal seal ring comprises a second groove complimentary to the groove in the first lateral face, the second groove located in the second lateral face radially outward of the second seal surface and configured to receive at least a portion of the annular debris barrier.

20. The drive assembly claim 18, wherein
the first metal seal ring further comprises:
a radial outer face; and
a flange extending radially outward from the radial outer face and proximate the first lateral face,
wherein the first lateral face extends along the flange and the laterally facing groove is formed in the flange.
